(19) United States
(12) Patent Application Publication
(10) Pub. No.: US 2006/0293026 A1
(43) Pub. Date: Dec. 28, 2006

(54) Method for monitoring and controlling a central ip budget available to a subscriber in a packet-based communication network during online charge assessment with monitoring Limit of data transmissions

(75) Inventors: Uwe Foll, Falkensee (DE); Wolfgang Hahn, Bergfelde (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/552,040

(22) PCT Filed: Apr. 4, 2003
(86) PCT No.: PCT/DE03/01225

§ 371 Date: Oct. 3, 2005

(51) Int. Cl. H04M 11/00

(52) U.S. Cl. 455/406

(57) ABSTRACT

The invention relates to a method for monitoring and controlling a central IP budget of a subscriber in a packet-based communication network during online charge assessment with the monitoring a maximum limit of data transmissions. The control function is provided in a network node of the communication network, administrated by the IP centre budget allocated by a charge computer and charges the central IP budget according to the assessment charges specified said charge computer during the use of resources for transmitting several data streams in a context which can be assigned to the subscriber by the central IP budget, the level of the charge being defined by a specific datastream.

### CLAIM FOR PRIORITY

This application is a national stage of PCT/DE2003/001225, published in the German language on Oct. 28, 2004, which was filed on Apr. 4, 2003.

### TECHNICAL FIELD OF THE INVENTION

The present invention relates to a method for monitoring and controlling an IP budget available centrally, and in paricular, to time, transmission volume, number of packets, of a subscriber in a packet-based communication network during online charge assessment with limit monitoring of data transmissions.

### BACKGROUND OF THE INVENTION

In wireless and wired communication networks, communication methods are frequently used which are based on the transmission of data packets (e.g. IP packets, IP=Internet Protocol). Such networks are referred to as packet-based communication networks. A packet-based communication network can, for example, be a third-generation mobile radio network which operates according to GPRS (GPRS=General Packet Radio System) specifications. In packet-based mobile radio networks one of the ways in which charges are recorded is on the basis of the IP packets transmitted. The charges are calculated in this case from the total volume of the IP packets transmitted from and to a user, their number and the number of data bytes. Likewise the charges can be determined on the basis of the transmission time. This use of resources is referred to within the context of this invention as the IP budget. Existing online charge services for GPRS are based on the monitoring of the IP budget for a PDP context. A PDP context is an example of what is known as a layer-2 connection of a subscriber to the communication network. The budget made available by the charge computer for a data stream is determined by current parameters, for example a subscriber credit, a bandwidth provided or by a quality-of-service (QoS) of a data stream. In this case there can be a number of data streams within a layer-2/PDP context. A concrete budget provided is always linked to the parameters of a data stream. if for example a budget makes 300 kB available, this budget can only be used for a data stream with the predetermined bandwidth or quality requirements. If, for example, the budget is actually provided for what is known as a “best effort” data stream, this budget cannot be used at the same level for another data stream, for example a “realtime” data stream. This means that it is necessary to differentiate the recording of transmission data, with the individual data streams differing within a layer-2/PDP context. Individual data streams in this case implement transactions of an application between two or more IP end points. In GPRS a control function, known as the IP Flow function, is defined for this purpose. With this concept the problem now arises of assigning budgets to the individual data stream. The question also arises of a methodology to be used in the event of the budget limit being reached, meaning in cases where the charge computer or online charging service cannot supply any further budget when requested to do so. Previously the entire PDP context was monitored by a control node of the GPRS network, by a so-called SGSN, and in the event of the budget limit being reached the connection was cleared down.

For implementing the IP Flow function the budgets would be assigned directly to the individual data streams and in the event of the budget limit being reached, the corresponding data stream would be interrupted, in which case the remaining data streams would still be maintained.

This concept is, however, very rigid in relation to budget distribution and does not allow any flexibility on reaching the budget limit as regards an actual data stream.

ETSI TS 132200 V 5. 3 (=3GPP TS 32.200) describes charging for a PDP context which can be used for offline charging.

### SUMMARY OF THE INVENTION

The present invention provides a method to divide up an IP budget available for a subscriber between the individual data streams in a flexible and simultaneously controlled manner.

In accordance with one embodiment of the invention, there is a method for monitoring and controlling an available IP budget of a subscriber in a packet-based communication network for online charge assessment with limit monitoring of data transmissions is provided in which a control function in a network node of the communication network is provided which manages a central IP budget and, in accordance with the charging specifications of a charge computer for resource usage of a data transmission of a number of data streams charges the central IP budget in a context which can be assigned to the subscriber in which case the extent of the charge is defined on a data stream-specific basis.

In a preferred embodiment of the invention, a GPRS network is used as a packet-based communication network. The control function is preferably located in this case in the GGSN of the GPRS network. In the GPRS example, as already explained at the start of this document, a number of data streams are to be found in a PDP context. As already explained a PDP context represents an example of what is known as a layer-2 connection of a subscriber to the communication network. There are also similar layer-2 connections in a WLAN (Wireless Local Area Network). The method in accordance with the invention can be used for any IP flows/data streams.

In another preferred embodiment of the invention, on the charge computer side, to determine the level of the charge on the central IP budget by the individual data streams, a data stream-specific weighting factor is specified in each case and after transmission of a data volume in the data stream the transmitted data volume is weighted by the control function with the weighting factor, a corresponding proportion of the IP budget is determined from this and the resulting proportion of the IP budget is deducted directly from the IP budget. This means that in this case no fixed data stream-specific IP budget is assigned in advance to the individual data streams, but an allocation is produced by the charge computer for the entire data streams of a subscriber or of an IP address of the subscriber or of a context of the subscriber. This means that the control function initially has the entire IP budget, for example of a subscriber or of an IP address or of a context available for distribution. Thus the entire IP budget is available equally to all data streams of a subscriber or an IP address of the subscriber or a context of the subscriber. Depending on the volume of data transmitted in the individual data streams the corresponding proportion of the IP budget determined by means of the data stream-specific weighting factor is then deducted directly from the IP budget. In this embodiment there exists a counter to which the entire weighted transmission volume is added and which is regularly compared with the prespecified IP budget.

In a further preferred embodiment of the invention, the central IP budget is charged for resource usage by those data streams which all belong to one context which can be assigned to an IP address of the same subscriber.

It is preferred if the central IP budget is charged for resource usages by those data streams which belong to the same context. In the case of GPRS this involves a layer-2 connection or a PDP context.

In still another embodiment in accordance with the invention, different data streams have to be charged differently to be handled very simply and flexibly. Accordingly, the data stream-specific parameters of the individual data streams are to be taken into account for charging the central IP budget. For this purpose, a weighting of the resource usage undertaken by the relevant data stream is performed before the central IP budget is charged. To do this in accordance with the invention, for charging the data stream the charge computer specifies to the control function as part of its assessment charges a data stream-specific conversion factor or weighting factor for determining the data stream-specific proportion of the IP budget. By means of this weighting factor the resource usage occurring in a transmission can be weighted in accordance with the specifications for the data stream. For example, there can be a data stream “Flow 1” with weighting factor 1=10 bytes per unit and a further data stream “Flow 2” with a weighting factor 2=20 kbytes per unit. For every 100 kbytes of the data stream “Flow 1” transmitted the central IP budget is charged with ten units, but for every 100 kbytes of the data stream “Flow 2” with five units.

Preferably, the charge computer can specify a weighting factor for each data stream and inform the control function about it. As an alternative to this, the charge computer can also transfer an index to a distribution table stored in the control function with the aid of which the definitive position in the table where the weighting factor concerned is stored is specified to the control function. As well as the weighting factors, the distribution table can also include further specifications relating to the corresponding data stream, for example prespecified priorities or information about whether the data stream is to be charged at all or is free-of-charge. This means that the control function for determining the weighting factor accesses a table which comprises data stream-specific assessment charges for data streams which can be assigned to a subscriber. In this case, the index can generally select a specific table for the subscriber in which the weighting factor can be addressed on the basis of the characteristics of the data stream or the index can simultaneously point to a specific weighting factor. This table is administered in a preferred embodiment of the invention in the control function. In addition, however, there is also the option of this table being able to be transferred by the charge computer or by another function to the control function. If new data streams which cannot yet be identified are added the distribution table is expanded by a new entry. Alternatively, an additional index to an existing table can also be specified by the charge computer.

In a further preferred embodiment of the invention, priorities are additionally defined for the individual data streams which are taken into account when the threshold value is reached for the rest of the budget. Thus, for example, a data stream which is marked out for signaling information can be handled with the greatest lifetime, that is with a high priority; the remaining data streams would be ended. This enables the guarantee to be provided that with the remaining budget a “minimum communication”, for example to top up the account by the subscriber side can be undertaken.

In yet another preferred embodiment of the invention, when a new data stream is added the existing IP budget continues to be used and a query is sent to the charge computer as to how resource usage by this data stream is to be weighted in relation to the IP budget.

In still another preferred embodiment of the invention, when a new data stream is added the existing IP budget continues to be used but an additional IP budget is assigned to the control function by the charge computer which adds this to the existing budget.

In a further preferred embodiment of the invention, the control function returns the IP budget to the charge computer when one of the data streams is ended. The charge computer, taking account of the new number and combination of data streams, then assigns a new IP budget to the control function.

In a further preferred embodiment of the invention, the control function informs the charge computer about the addition or removal of one of the data streams. The charge computer then informs the control function about how the existing IP budget is to continue to be used.

In a further preferred embodiment of the invention, the charge computer requests the return of the IP budget on the addition or removal of a data stream and sends the control function a new IP budget, taking into account the characteristics of the new data stream as well as the combination of the different data streams. This is especially useful to adapt the overall budget of the subscriber to the new circumstances.

In a further embodiment of the invention, the charge computer notifies the control function by means of the table or pointer to a position in a table as to the weighting factor with which the IP budget of a data stream is to be newly weighted in the event of a parameter change (e.g. Qos change).

### BRIEF DESCRIPTION OF THE DRAWINGS

The present invention is described in more detail below with reference to the exemplary embodiments and drawings, in which:

FIG. 1 shows an embodiment of the method in accordance with the invention.

### DETAILED DESCRIPTION OF THE INVENTION

FIG. 1 shows an embodiment of the method in accordance with the invention. It shows a charge computer 1, a control function 2 and a layer-2 connection 3. For a subscriber TE the layer-2 connection 3 is established by means of a mobile station MS via an access network in the packet-based communication network. The layer-2 connection 3 includes a number of data streams 4.1.-4.3. Charge computer 1 specifies data stream-specific weighting factors 6.1.-6.3 to control function 2 for charging the relevant data stream. Control function 2 administers an IP budget 7. After transmission of a data volume in a data stream, for example in data stream 4.1., the transmitted data volume is weighted by means of the weighting factor 6.1. by the control function 2. Form this a corresponding proportion of the IP budget 7 is determined by the control function 2. The proportion of the IP budget 7 produced is then deducted directly from the IP budget 7. This means that, in this case, in advance of the individual data streams 4.1.-4.3. no fixed data stream-specific proportions of the IP budgets 7 are assigned. This means that the IP budget is initially available to the control function 2 for distribution. The IP budget 7 can in this case be the budget which has been assigned by the charge computer to a subscriber, to an IP address or to a context. The entire IP budget 7 is thus available equally to all the relevant data streams 4.1.-4.3. that can be assigned. Depending on the transmitted data volume in the individual data streams 4.1.4.3., the appropriate proportion of the IP budget 7 determined by means of the data stream-specific weighting factor 6.1.-6.3. is then deducted directly. To determine the relevant weighting factors 6.1.-6.3. the control function 2 accesses a table which comprises the charging specifications for all data streams which can be assigned to a subscriber. There are now a number of options as to how the corresponding weighting factors are specified to the control function 2. In one option the charge computer 1 can transfer an index to the table stored in the control function 2. In this case, the Index can generally select a table specific to the subscriber, in which the weighting factors can be addressed on the basis of the characteristics of the corresponding data stream or the index can point directly to a specific weighting factor. This table is administered statically in control function 2 for example. However there is also the option of the table being transmitted by the charge computer 1 or by another function to control function 2.

1. A method for monitoring and control of an IP budget of a subscriber available in a packet-based communication network during online charge assessment of data transmissions, comprising:
providing a control function in a network node of the communication network which administers a central IP budget assigned by a charge computer; and
charging a central IP budget, with a level of the charge being determined on a data stream-specific basis in accordance with assessment charges of the charge computer, for usage of resources of a data transmission of a number of data streams in a context which can be assigned to a subscriber.

2. The method in accordance with claim 1, wherein
a data stream-specific conversion factor or weighting factor is specified on the charge computer side for determining the level of the charger by a data stream, after transmission of a data volume in the data stream the transmitted data volume is weighted by the control function with the weighting factor, from this a corresponding proportion of the IP budget is determined and the proportion of the IP budget produced from this is deducted directly from the IP budget.

3. The method in accordance with claim 1, wherein
to determine the weighting factor, the control function accesses a table which comprises data stream-specific assessment charges for data streams which can be assigned to a subscriber.

4. The method in accordance with claim 1, wherein
a GPRS network is used as the packet-based communication network.

5. The method in accordance with claim 4, wherein
the control function is located in a GGSN.

6. The method in accordance with claim 1, wherein when a new data stream is added, at least one of a new weighting factor, a new table, and an index to or identifier for a table element is transferred by the charge computer to the control function.

7. The method in accordance with claim 1, wherein
the central IP budget is charged for resource usage by those data streams which belong to one context to which an IP address of a same subscriber can be assigned.

8. The method in accordance with claim 1, wherein
the central IP budget is charged for usage of resources by those data streams which belong to a same context.

9. The method in accordance with claim 1, wherein
on addition of a new data stream and usage of resources on part of the new data stream the existing IP budget is charged.

10. The method in accordance with claim 9, wherein
the charge computer allocates to the control function an additional IP budget for administration.

11. The method in accordance with claim 1, wherein
the control function, on addition and/or removal of at least one data stream, transfers a remaining IP budget to the charge computer and the charge computer assigns the control function a new IP budget.

12. The method in accordance with claim 1, wherein
the control function informs the charge computer about the addition and/or removal of a data stream and the charge computer gives the control function specifications about another use of the IP budget.

13. The method in accordance with claim 2, wherein
the charge computer informs the control function by means of a table or a pointer to a position in a table about the weighting factor with which a transmitted data volume in a data stream is to be newly weighted in the event of a parameter change.
